(19) United States
(12) Patent Application Publication
(10) Pub. No.: US 2012/0277957 A1
(43) Pub. Date: Nov. 1, 2012

(54) DRIVING ASSIST DEVICE

(76) Inventors: Satoru Inoue, Tokyo (JP); Tatsuya Mitsugi, Tokyo (JP); Yukio Nishimoto, Tokyo (JP)

(21) Appl. No.: 13/520,088

(22) PCT Filed: Apr. 15, 2010
(86) PCT No.: PCT/JP2010/002739

§ 371 Date: Jun. 29, 2012

(51) Int. Cl. G05D 1/00

(52) U.S. Cl. 701/41

(57) ABSTRACT

A driving assist device detects the position of a vehicle 13 in a direction of the width of a road by using both distance data on both right and left sides of the vehicle and road width data on the width of the road, specifies distance data having a time-varying change equal to or larger than a predetermined threshold from among the distance data showing the vehicle position detected to correct the vehicle position in such a way that the vehicle position is shown by the distance data from which the distance data specified are removed when the travelling path of the vehicle 13 shows a straight ahead movement, determines the travelling state of the vehicle 13 from a time-varying change of the vehicle position corrected, and notifies a content according to the travelling state determined.

### FIELD OF THE INVENTION

The present invention relates to a driving assist device which notifies the position of a vehicle in a direction of the width of a travel path, a space between vehicles, and the result of determination of a travelling state to the driver to assist the driver in driving the vehicle.

### BACKGROUND OF THE INVENTION

A conventional system disclosed by patent reference 1 acquires the position of a vehicle in a direction of the width of a travel path with reference to side walls or guardrails on both the sides of the travel path which are detected by sensors disposed in the vehicle, and determines a lane in which the vehicle is currently travelling from the position of the vehicle in the direction of the width of the travel path, the number of lanes of the travel path along which the vehicle is currently travelling, and information about the width of the travel path which are acquired from a navigation system. This system directs the driver to change lanes or the like according to the determination result.

The above-mentioned system successively detects the distance from the vehicle to an object, such as a side wall or a guardrail, by using a distance sensor when the vehicle is travelling, and complements these distance data with a straight line. When the straight line has a sloping angle exceeding a fixed angle (5 degrees), the system determines that the detected object is neither a side wall nor a guardrail which is disposed along the travel path.

However, when having detected another vehicle travelling in an adjacent lane by using the distance sensor while the vehicle travels along a road having a plurality of lanes, the system determines that the detected object is neither a side wall nor a guardrail because the above-mentioned sloping angle exceeds the fixed angle. That is, a problem is that when another vehicle is travelling in a side lane in parallel with the vehicle, the system becomes unable to constantly detect the distance from an object (e.g. a side wall or a guardrail) on a side of the road to the vehicle and the reliability of the result of the determination of the driving lane is reduced.

The present invention is made in order to solve the above-mentioned problem, and it is therefore an object of the present invention to provide a driving assist device which can correctly measure the position of a vehicle in a direction of the width of a road along which the vehicle is travelling, and can assist in driving the vehicle according to the travelling state of the vehicle which the driving assist device has determined from the vehicle position.

### RELATED ART DOCUMENT

### Patent Reference

Patent reference 1: Japanese Unexamined Patent Application Publication No. 2003-106859

### SUMMARY OF THE INVENTION

In accordance with the present invention, there is provided a driving assist device including: a vehicle position detecting unit for detecting a position of a vehicle in a direction of a width of a road along which the vehicle is travelling by using both distance data on at least one of distances from both right and left side surfaces of the vehicle to an object to be detected which are detected by distance sensors mounted on both the right and left side surfaces of the vehicle for detecting the distances from the both side surfaces to an object, and road width data on the width of the road which is specified from map information by using vehicle position information; a vehicle position correcting unit for determining a travelling path of the vehicle on a basis of wheel speeds of right and left wheels of at least one of front and rear wheelsets of the vehicle, the wheel speeds being detected by wheel speed sensors for detecting the wheel speeds of the right and left wheels, and for specifying distance data having a time-varying change equal to or larger than a predetermined threshold from among the distance data showing the vehicle position which is detected by the vehicle position detecting unit to correct the vehicle position in such a way that the vehicle position is shown by the distance data from which the specified distance data are removed when the travelling path of the vehicle shows a straight ahead movement; a travelling state determination unit for determining a travelling state of the vehicle from a time-varying change of the vehicle position in the direction of the width of the road which is corrected by the vehicle position correcting unit; and a notification unit for notifying a content according to the travelling state determined by the travelling state determination unit.

The driving assist device in accordance with the present invention detects the position of the vehicle in the direction of the width of the road by using both the distance data on at least one of both the right and left sides of the vehicle and the road width data on the width of the road, specifies the distance data having a time-varying change equal to or larger than the predetermined threshold from among the distance data showing the vehicle position detected to correct the vehicle position in such a way that the vehicle position is shown by the distance data from which the distance data specified are removed when the travelling path of the vehicle shows a straight ahead movement, determines the travelling state of the vehicle from a time-varying change of the vehicle position corrected, and notifies a content according to the travelling state determined. By doing in this way, the driving assist device provides an advantage of being able to correctly measure the vehicle position in the direction of the width of the road, and being able to perform a driving assist according to the travelling state of the vehicle determined from the measured vehicle position.

### BRIEF DESCRIPTION OF THE FIGURES

FIG. 1 is a diagram showing the structure of a driving assist system in accordance with the present invention;

FIG. 2 is a block diagram showing the function configuration of a driving assist device in accordance with Embodiment;

FIG. 3 is a top plan view showing an example of the arrangement of sensors in a vehicle in which the driving assist device in accordance with Embodiment 1 is mounted;

FIG. 4 is a view showing an example in which the driving assist device performs a driving assist in accordance with the present invention;

FIG. 5 is a view for explaining a process of determining the travelling path of the vehicle;

FIG. 6 is a view showing a case in where the vehicle is travelling in parallel with another vehicle travelling in an adjacent lane (time t1);

FIG. 7 is a view showing a case in where the vehicle is travelling in parallel with the other vehicle travelling in an adjacent lane (time t2);

FIG. 8 is a view showing a case in where the vehicle is travelling in parallel with the other vehicle travelling in an adjacent lane (time t3);

FIG. 9 is a view showing a case in where the vehicle is travelling in parallel with the other vehicle travelling in an adjacent lane (time t4);

FIG. 10 is a view for explaining a correction on the position of the vehicle in a direction of the road width;

FIG. 11 is a view showing a change in distance data in a case in which an obstacle exists on one side of the vehicle;

FIG. 12 is a view for explaining a process of determining the travelling state of the vehicle which is carried out by a travelling state determination unit in accordance with Embodiment 2; and

FIG. 13 is a view for explaining adjustment of the transmission sensitivity and the reception sensitivity of each ultrasonic sensor which is carried out by a vehicle position correcting unit in accordance with Embodiment 3.

### EMBODIMENTS OF THE INVENTION

Hereafter, in order to explain this invention in greater detail, the preferred embodiments of the present invention will be described with reference to the accompanying drawings.

### Embodiment 1

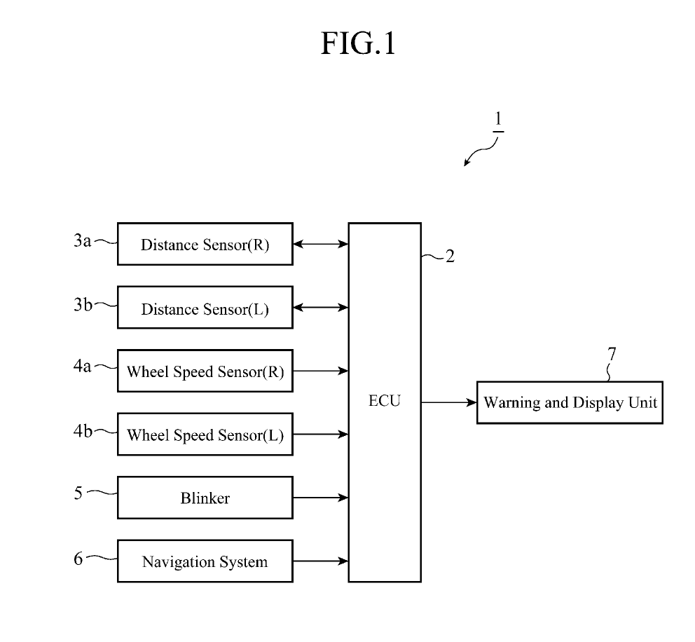

FIG. 1 is a view showing the structure of a driving assist system in accordance with the present invention. Referring to FIG. 1, the driving assist system 1 is provided with a driving assist device which is constructed in an ECU (Electric Control Unit) 2 which carries out electronic control in a vehicle, distance sensors 3a and 3b, wheel speed sensors 4a and 4b, a blinker 5, a navigation system 6, and an output unit 7. The distance sensors 3a and 3b are disposed on right and left side surfaces of a front portion or a rear portion of the vehicle, and each of the distance sensors applies a detection wave and receives a reflected wave of the detection wave from an object to be detected to detect the distance between the sensor and the object to be detected. As the detection wave, an ultrasonic wave, a laser beam, a radio wave, or the like is provided.

The wheel speed sensors 4a and 4b are disposed for the right and left rear wheels of the vehicle, respectively, and each of the sensors detects the wheel speed of the corresponding wheel (a pulse number according to the rotation of the wheel). The wheel speed data detected by the wheel speed sensors 4a and 4b are outputted to the ECU 2. Operation information (direction indication) about an operation using the blinker 5 which is done by the driver is transmitted to the ECU 2. The ECU 2 acquires map information including the number of lanes of a road along which the vehicle is travelling and the width of the road, and GPS (Global Positioning System) information about the position of the vehicle from the navigation system 6.

The navigation system 6 acquires road information about the road along which the vehicle is travelling from a map information database while detecting the current position of the vehicle via the GPS receiver. The output unit 7 presents driving assist information to the driver, and is comprised of a display monitor, a sound speaker, etc. which are pieces of vehicle-mounted equipment.

The ECU 2 determines the driving lane of the vehicle, and the position of the vehicle in the driving lane in a direction of the width of the road by using the distance data detected by the distance sensors 3a and 3b, the wheel speed data on the wheel speeds of the right and left rear wheels of the vehicle detected by the wheel speed sensors 4a and 4b, the operation information about an operation on the blinker 5, the road width data of the map information acquired from the navigation system 6, and the vehicle position information acquired from the GPS information.

In addition, the ECU 2 outputs a warning by voice via the output unit 7, and displays a text and an icon showing the descriptions of the warning. For example, the ECU determines the travelling state of the vehicle, such as travelling on road shoulder or unsteady travelling, and a positional relationship (approaching, parallel travelling or moving away) between another vehicle travelling in an adjacent lane and the vehicle, and gives the driver a warning and assists the driver in driving the vehicle.

Because the ECU 2 thus functions as the driving assist device in accordance with the present invention, the ECU will be described as the driving assist device 2 from here on when deemed appropriate.

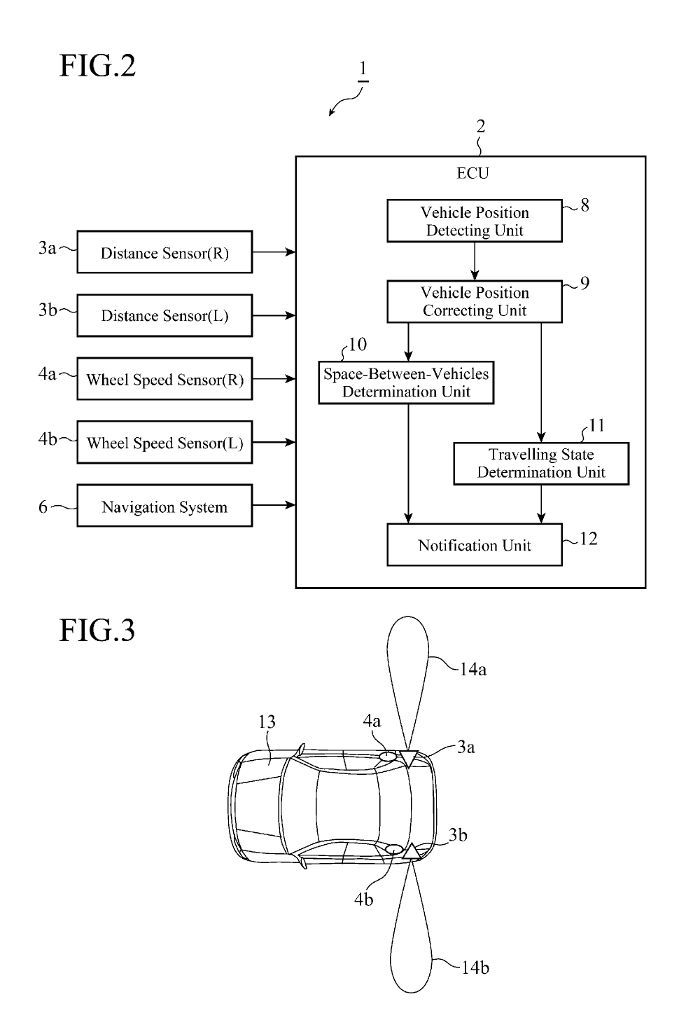

FIG. 2 is a block diagram showing the function configuration of the driving assist device in accordance with Embodiment 1, and shows the function configuration of a part of the ECU 2 of FIG. 1 which functions as the driving assist device. As shown in FIG. 2, the ECU 2 is provided with a vehicle position detecting unit 8, a vehicle position correcting unit 9, a space-between-vehicles determination unit 10, a travelling state determination unit 11, and a notification unit 12 as the function configuration of the driving assist device. The vehicle position detecting unit 8 is a component for acquiring the vehicle position information and the map information from the navigation system 6, and for detecting the position of the vehicle in the direction of the width of the road by using both the distance data detected by at least one of the distance sensors 3a and 3b mounted on the side surfaces of the vehicle, and the road width data on the width of the road along which the vehicle is travelling, the road width data being specified from the map information by using the vehicle position information.

The vehicle position correcting unit 9 is a component for specifying the distance shown by the distance data which changes due to an obstacle (another vehicle travelling in an adjacent lane, or the like) appearing between the vehicle and an object on a side of the road from the distance data showing the position of the vehicle in the direction of the width of the road detected by the vehicle position detecting unit 8 by using either the travelling path of the vehicle and the sum of the distance data detected by the distance sensors 3a and 3b mounted on the right and left side surfaces of the vehicle, or the road width data of the map information and the distance data detected by either one of the distance sensors 3a and 3b to correct the position of the vehicle in such a way that the position is shown by the distance data from which the specified distance data is removed.

The space-between-vehicles determination unit (vehicle space determination unit) 10 is a component for successively receiving the distance data which the vehicle position correcting unit 9 has determined have a time-varying change equal to or larger than a predetermined threshold, and, when the distance shown by the distance data decreases with the passage of time, determines that the vehicle and an object to be detected are approaching each other, and for, when the distance shown by the distance data then increases after being held constant for a short time, determines that the object to be detected has moved away from the vehicle after travelling in parallel with the vehicle. For example, the space-between-vehicles determination unit determines the space between the vehicle and another vehicle travelling in an adjacent lane.

The travelling state determination unit 11 is a component for determining the travelling state of the vehicle from a time-varying change in the position of the vehicle corrected by the vehicle position correcting unit 9.

The notification unit 12 is a component for notifying the position of the vehicle in the direction of the width of the road, the space between the vehicle and another vehicle which is detected by the space-between-vehicles determination unit 10, and the travelling state of the vehicle determined by the travelling state determination unit 11, and outputs an information content via the output unit 7 shown in FIG. 1.

FIG. 3 is a top plan view showing an example of the arrangement of the sensors of the vehicle in which the driving assist device in accordance with Embodiment 1 is mounted. As shown in FIG. 3, the distance sensors 3a and 3b are disposed on right and left sides of a rear portion of the vehicle 13. Because what is necessary is just to dispose the distance sensors 3a and 3b on right and left sides of at least one of front and rear portions of the vehicle, the distance sensors can be disposed on right and left sides of a front portion of the vehicle or on right and left sides of each of both front and rear portions of the vehicle. In the following explanation, a case in which ultrasonic sensors (R) and (L) each of which uses an ultrasonic wave as a detection wave is used as the distance sensors 3a and 3b will be explained.

Each of the ultrasonic sensors 3a and 3b receives an echo (reflected wave) of the ultrasonic wave (detection wave) reflected by an object to be detected which enters its detection area 14a or 14b to measure the distance from itself to the object to be detected. The wheel speed sensors 4a and 4b are disposed for the right and left rear wheels of the vehicle 13 and detect the rotational speeds of the wheels of the vehicle 13, respectively. Because what is necessary is just to dispose the wheel speed sensors 4a and 4b for the right and left wheels in at least one of the front and rear wheelsets of the vehicle, the wheel speed sensors can be disposed for the right and left wheels in the front wheelset or for the right and left wheels in each of the front and rear wheelsets.

Next, the operation of the driving assist device will be explained.

First, a case in which no obstacle (no other vehicle travelling in an adjacent lane or the like) exists between each of the ultrasonic sensors disposed on the right and left sides of the rear portion of the vehicle 13 and the corresponding one of side walls disposed opposite to each other with a road, along which the vehicle 13 is travelling, being sandwiched by the side walls will be explained.

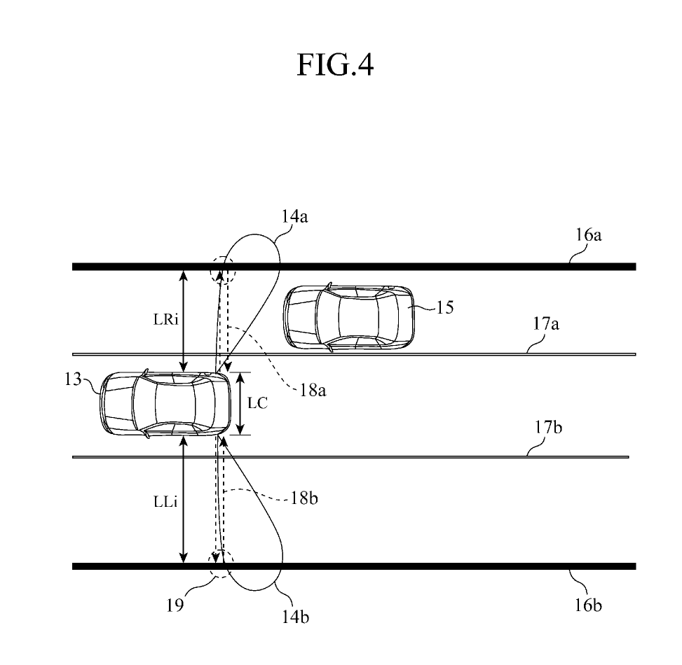

FIG. 4 is a view showing an example in which the driving assist device performs a driving assist in accordance with the present invention. In the example of FIG. 4, the vehicle 13 in which the driving assist device 1 in accordance with the present invention is mounted is travelling in the center lane of the road having three lanes divided with white lines 17a and 17b. When the vehicle 13 is travelling, the detection areas 14a and 14b of the ultrasonic sensors 3a and 3b are formed in such a way as to extend toward the side walls 16a and 16b disposed opposite to each other with the road being sandwiched by the side walls, respectively.

When no other vehicle 15 travelling in an adjacent lane exists in the detection area 14a, only the side walls 16a and 16b are objects to be detected, reflected waves (ultrasonic echoes) of the ultrasonic waves reflected from reflection areas 19 of the ultrasonic waves are received by the ultrasonic sensors 3a and 3b after passing through propagation paths 18a and 18b, and the distances from the vehicle 13 to the side walls 16a and 16b are acquired.

When the road width is nearly constant, the road width is given by LC+LR(i)+LL(i), where the width of the vehicle 13 is expressed as LC, the distance from the vehicle 13 to the side wall 16a (right-hand side distance) is expressed as LR(i), and the distance from the vehicle 13 to the side wall 16b (left-hand side distance) is expressed as LL(i). In the above equation, i=1, 2, 3, and

The vehicle position detecting unit 8 acquires the vehicle position information and the map information from the navigation system 6, detects the position of the vehicle in the direction of the width of the road along which the vehicle is travelling by using time series information of the distance data detected by the ultrasonic sensors 3a and 3b, and the road width data on the road along which the vehicle is currently travelling, the road width data being determined from the map information by using the vehicle position information.

The vehicle position correcting unit 9 determines the travelling path of the vehicle 13 from the wheel speed data on the wheel speeds of the right and left wheels detected by the wheel speed sensors 4a and 4b.

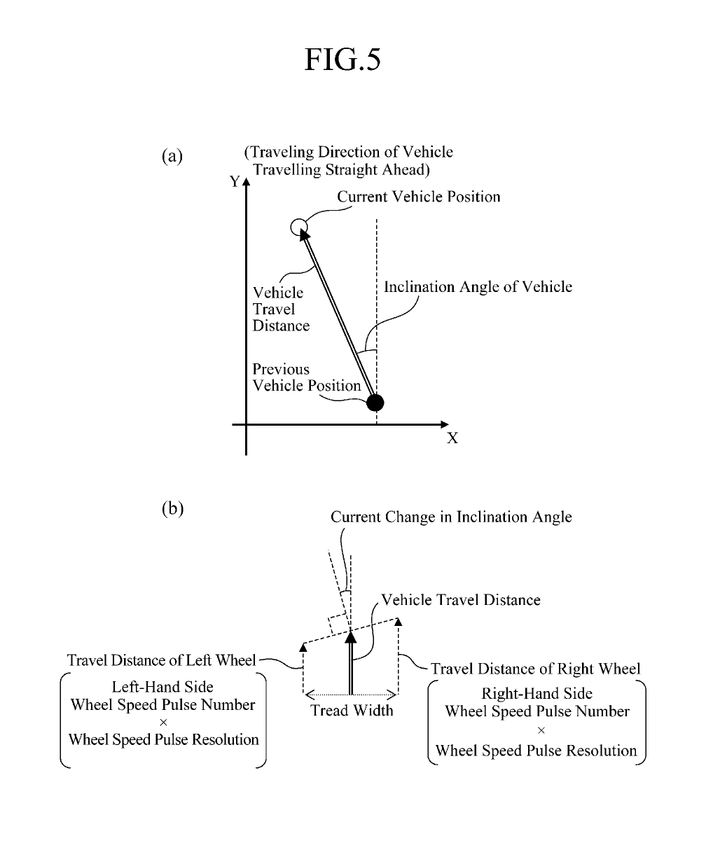

FIG. 5 is a view for explaining a process of determining the travelling path of the vehicle. The vehicle position correcting unit 9 determines the travelling path of the vehicle according to an inclination angle of the vehicle in the travelling direction of the vehicle, the inclination angle occurring until the vehicle reaches the current vehicle position, with reference to a straightforward direction of the vehicle at the previous vehicle position, as shown in FIG. 5(a).

Concretely, the vehicle position correcting unit 9 successively acquires the wheel speed pulses of each of the right and left wheels from the wheel speed sensors 4a and 4b, and determines wheel travel distances from the previous vehicle position to the current vehicle position by multiplying each of the numbers of the wheel speed pulses by a wheel speed pulse resolution (calculating a time integration of the wheel speed pulses), as shown in the FIG. 5(b).

At this time, the vehicle position correcting unit determines a change in the current inclination angle with respect to a direction which perpendicularly intersects the middle point of the tread width from the difference between the travel distances of the right and left wheels. By thus determining the inclination angle with respect to the travelling direction of the vehicle successively, the vehicle position correcting unit acquires the travelling path data of the vehicle.

Furthermore, when the travelling path of the vehicle shows a straight ahead movement, and the sum (LL(i)+LR(i)) of the distance data on both the right and left sides of the vehicle showing the vehicle position detected by the vehicle position detecting unit 8 is stable and constant, the vehicle position correcting unit 9 assumes that the road width of the road along which the vehicle 13 is travelling is uniform.

For example, when an error in the LL(i)+LR(i) falls within a constant permissible range during a predetermined period, the vehicle position correcting unit assumes that the road width is uniform. After assuming that the road width is uniform, the vehicle position correcting unit 9 corrects the influence of another vehicle travelling in an adjacent lane or the like which will be mentioned later under the assumption that the road width is uniform.

The travelling state determination unit 11 successively receives the distance data on both the right and left sides of the vehicle via the vehicle position correcting unit 9 as the time series information showing the vehicle position in the direction of the road width, and determines the travelling state of the vehicle from this time series information. For example, when there is no change in the time series information showing the vehicle position in the direction of the road width and the travelling path data of the vehicle shows a straight ahead movement, the travelling state determination unit determines that the vehicle is travelling straight ahead with stability.

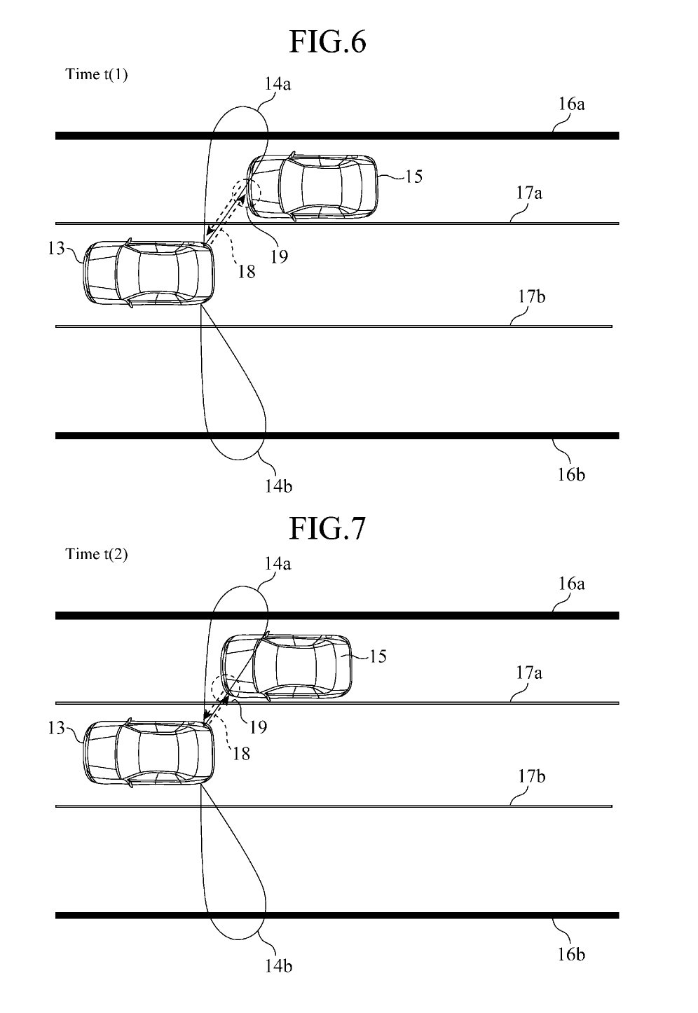

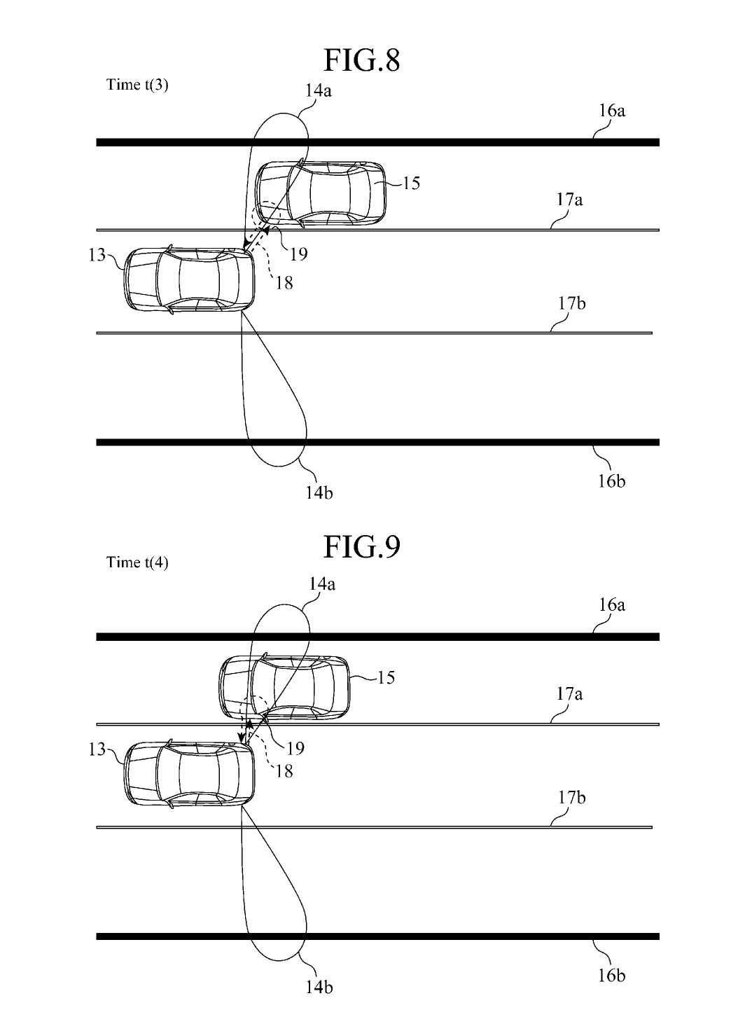

Next, a case in which another vehicle 15 travelling in an adjacent lane catches up with the vehicle 13 travelling along the road having three lanes shown in FIG. 4, travels in parallel with the vehicle 13, and passes and moves away from the vehicle 13, as shown in FIGS. 6 to 9, and the distance data measured on both the right and left sides of the vehicle 13 change according to the series of travelling states of the vehicle 13 will be explained.

FIGS 6 to 9 are views showing the case in which the other vehicle 15 catches up with the vehicle 13, and travels in parallel with the vehicle 13 with the passage of time. In these views, time passes in the following order: time t(1)→time t(2)→time t(3)→time t(4).

Unless no vehicle travelling in an adjacent lane exists in either one of the detection areas 14a and 14b, the driving assist device 2 of the vehicle 13 acquires the distance from the vehicle 13 to each of the side walls 16a and 16b by using the ultrasonic sensors 3a and 3b. At the time t(1) shown in FIG. 6 at which the other vehicle 15 travelling in an adjacent lane catches up with the vehicle 13 and comes to the detection area 14a, the ultrasonic sensor 3a starts measuring the distance between the vehicle 13 and the other vehicle 15.

After that, as shown in FIGS. 7 to 9, when time passes from the time t(2) to the time t(4), and the other vehicle 15 travels in parallel with the vehicle 13, the reflection area 19 of the ultrasonic wave emitted from the ultrasonic sensor 3a moves from the left front corner of the other vehicle 15 to the left lateral side of the other vehicle 15. In the state in which the other vehicle 15 is travelling in parallel with the vehicle 13, the space between the vehicle 13 and the left lateral side of the other vehicle 15 is nearly constant.

Also in the travelling states shown in FIGS. 6 to 9, the vehicle position detecting unit 8 detects the vehicle position data on the position of the vehicle in the direction of the width of the road, and successively outputs the vehicle position data detected thereby to the vehicle position correcting unit 9, like in the case in which no obstacle (no other vehicle travelling in an adjacent lane or the like) exists between the vehicle 13 and each of the side walls disposed opposite to each other with the road, along which the vehicle 13 is travelling, being sandwiched by the side walls.

The vehicle position correcting unit 9 carries out a correcting process of removing the data including a change in the distance data which is caused by the other vehicle 15 travelling in an adjacent lane from the vehicle position data on the position of the vehicle in the direction of the road width detected by the vehicle position detecting unit 8.

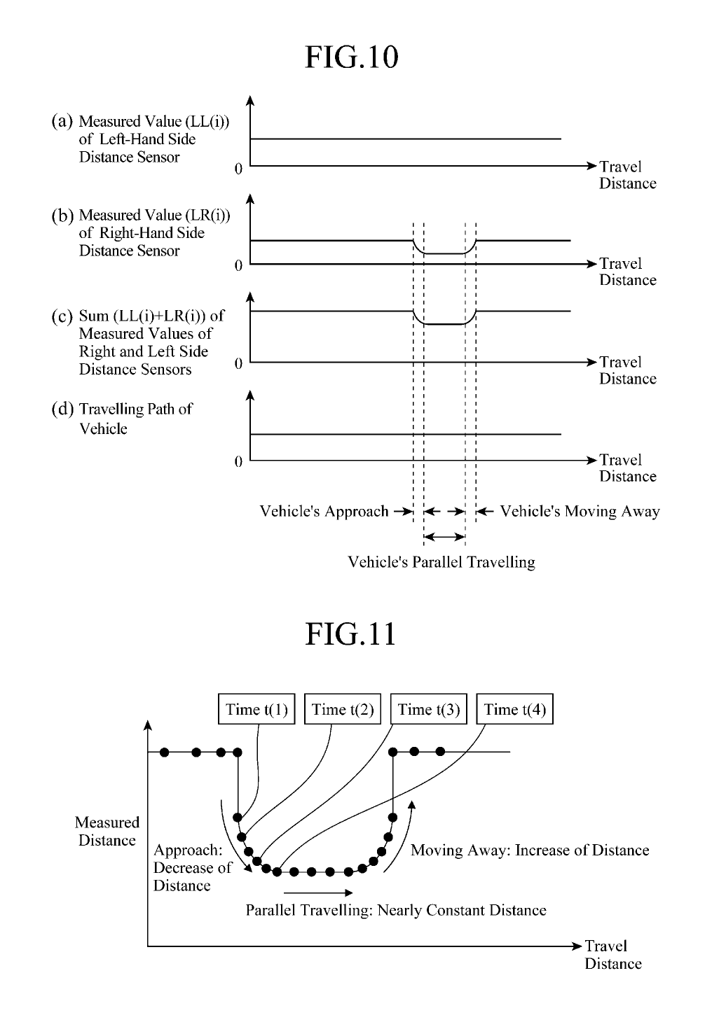

FIG. 10 is a view for explaining a process of correcting the vehicle position in the direction of the road width, and shows the distance data on both the right and left sides of the vehicle 13, the sum of the distance data on both the right and left sides of the vehicle, and the travelling path data of the vehicle 13 in the travelling states of FIGS. 6 to 9, which are acquired at the time that the vehicle 13 in which the driving assist device 1 is mounted is caught up with by the other vehicle 15 travelling in an adjacent lane (a right-hand side lane) (approach of vehicle), after the time that the other vehicle 15 is travelling in parallel with the vehicle 13 (travelling in parallel with vehicle), and at the time that the vehicle 13 is passed by the other vehicle 15 (moving away of vehicle). A case in which the sum of the distance data on both the right and left sides of the vehicle 13 is constant, and the road width is uniform is shown in FIG. 10.

Referring to FIG. 10(a), because there is no vehicle in the adjacent lane on the left-hand side of the vehicle 13, no vehicle exists in the detection area 14a of the ultrasonic sensor 3b and the object to be detected is the side wall 16b. At this time, a reflected wave (ultrasonic echo) of the ultrasonic wave reflected from the reflection area 19 of the ultrasonic wave is received by the ultrasonic sensor 3b after passing through the propagation path 18, and the distance LL(i) from the vehicle 13 to the side wall 16b is acquired.

In contrast, the other vehicle 15 is travelling in the adjacent lane on the right-hand side of the vehicle 13, and catches up with the vehicle 13 (approach of vehicle) and, after travelling in parallel with the vehicle (travelling in parallel with vehicle), passes the vehicle (moving away of vehicle), as shown in FIGS. 6 to 9. The ultrasonic sensor 3a of the vehicle 13 detects the other vehicle 15 at the time t(1), and starts measuring the distance between the vehicle 13 and the other vehicle 15. After that, as time passes from the time t(2) to the time t(3) and the other vehicle 15 approaches the vehicle, the distance shown by the distance data LR(i) detected by the ultrasonic sensor 3a decreases as shown in FIG. 10(b).

In addition, when time passes and reaches the time t(4) that the other vehicle 15 is travelling in substantially parallel with the vehicle 13, the distance data LR(i) detected by the ultrasonic sensor 3a shows a nearly fixed distance as shown in FIG. 10(b). More specifically, the vehicle 13 is placed in a state in which the vehicle is travelling in parallel with the other vehicle 15 with a nearly constant space between them. After that, because the other vehicle 15 moves outside of the detection area 14a as the other vehicle 15 passes the vehicle 13 and moves away from this vehicle, the object to be detected of the ultrasonic sensor 3a returns to the side wall 16a again, and the distance between the vehicle and the side wall 16a is measured. When the other vehicle 15 passes the vehicle 13 and moves away from this vehicle in this way, the distance shown by the distance data LR(i) detected by the ultrasonic sensor 3a increases as shown in FIG. 10(b). This series of changes in the distance data LR(i) is shown in FIG. 11.

The vehicle position correcting unit 9 successively receives the distance data LL(i) and LR(i) showing the vehicle position detected by the vehicle position detecting unit 8, and calculates the difference (LL(i)−LR(i)) between them and also calculates a time-varying change ΔL(i) in the distance difference according to the following equation, where i=1, 2, 3, and . . . , and t(i) is time.

ΔL(i)=(L(i)−L(i+1)/(t(i)−t(i+1)

Next, when the time-varying change ΔL(i) is equal to or larger than a predetermined threshold even though the travelling path data of the vehicle 13 shows a straight ahead movement, as shown in FIG. 10(d), the vehicle position correcting unit 9 determines that a change has occurred in either one of the right-hand side and left-hand side distance data due to an object to be detected (a vehicle travelling in an adjacent lane, or the like) which exists on either one of the right and left sides of the vehicle 13, removes the distance data in which the vehicle position correcting unit has determined the change has occurred due to the object to be detected which exists on either one of the right and left sides of the vehicle 13 from the distance data showing the vehicle position detected by the vehicle position detecting unit 8 and corrects the vehicle position in such a way that the vehicle position is shown by the remaining distance data.

As an alternative, by using, instead of the distance data on both the right and left sides of the vehicle showing the vehicle position detected by the vehicle position detecting unit 8, the distance data on either one of both the right and left sides and the road width data acquired from the map information, the vehicle position correcting unit calculates the time-varying change ΔL(i), and, when ΔL(i) is equal to or larger than the predetermined threshold, determines that the distance data have the change because an object to be detected exists on either one of the right and left sides of the vehicle 13.

The travelling state determination unit 11 successively receives the vehicle position data corrected by the vehicle position correcting unit 9 in the series of travelling states shown in FIGS. 6 to 9, and determines the travelling state of the vehicle 13 by using this time series information of the vehicle position data. In this embodiment, because the influence of the object to be detected (the other vehicle 15) is corrected by the vehicle position correcting unit 9, a problem of being unable to constantly detect the distance from an object ((e.g. a side wall or a guardrail) on a side of the road to the vehicle, which conventionally occurs when another vehicle travelling in a side lane is travelling in parallel with the vehicle, does not occur.

On the other hand, in the series of travelling states shown in FIGS. 6 to 9, the vehicle position correcting unit 9 outputs the distance data in which the vehicle position correcting unit has determined a change has occurred due to the other vehicle 15 travelling in an adjacent lane to the space-between-vehicles determination unit 10. The space-between-vehicles determination unit 10 detects the space between the vehicle 13 and the other vehicle 15 approaching the vehicle 13, the space between the vehicle 13 and the other vehicle 15 travelling in parallel with the vehicle 13, or the space between the vehicle 13 and the other vehicle 15 moving away from the vehicle 13 by using the distance data inputted thereto from the vehicle position correcting unit 9.

For example, the space-between-vehicles determination unit can determine the position of the front left corner of the other vehicle 15 approaching the vehicle 13 by using the distance data inputted thereto in time series from the vehicle position correcting unit 9, and can detect the space between the vehicle 13 and the corner of the other vehicle 15. The driving assist device can cause the notification unit 12 to notify the space between the vehicle 13 and the other vehicle which is detected by the space-between-vehicles determination unit 10.

Further, when the time-varying change ΔL(i) in the distance data successively inputted thereto from the vehicle position correcting unit 9 is equal to or larger than a predetermined threshold (±ΔL), and the distance shown by the distance data decreases with the passage of time, the space-between-vehicles determination unit 10 determines that another vehicle travelling in an adjacent lane (the other vehicle 15) is approaching the vehicle 13.

At this time, when the driver operates the blinker 5 and is going to change lanes, the driving assist device commands the notification unit 12 to give a warning showing the approach of the other vehicle 15 or produce an alarm display showing the approach of the other vehicle 15. As a result, the driver's attention is called.

When time further passes, and the distance shown by the distance data successively inputted from the vehicle position correcting unit 9 increases after being held constant for a short time, the space-between-vehicles determination unit 10 determines that the other vehicle 15 has moved away from the vehicle 13 after travelling in parallel with the vehicle 13. In this case, the notification unit 12 can notify the driver that the other vehicle 15 has moved away from the vehicle 13.

Further, when the travelling state determination unit 11 compares the time series information showing the vehicle position in the direction of the road width which is corrected by the vehicle position correcting unit 9 with the map data on the road along which the vehicle 13 is currently travelling which are acquired from the navigation system 6, and then determines that the vehicle 13 has deviated from the driving lane without being synchronized with the direction indication of the blinker 5, the travelling state determination unit commands the notification unit 12 to notify to that effect. As a result, the notification unit 12 notifies the driver that the driver has changed lanes without performing any direction indication via the blinker 5 by using a warning or an alarm display. By thus calling the driver's attention, the driving assist device can improve the safety of the vehicle at the time that the vehicle deviates from the driving lane.

As mentioned above, the driving assist device in accordance with this Embodiment 1 detects the position of the vehicle in the direction of the width of the road by using the distance data on both the right and left sides of the vehicle 13 and the road width data on the road, and, when the travelling path of the vehicle 13 shows a straight ahead movement, specifies the distance data having a time-varying change equal to or larger than a predetermined threshold from the distance data showing the detected position of the vehicle to correct the vehicle position in such a way that the vehicle position is shown by the distance data from which the specified distance data is removed, determines the travelling state of the vehicle 13 from the time-varying change in the corrected vehicle position, and notifies a content according to the determined travelling state to the driver. By doing in this way, even if another vehicle 15 is travelling in an adjacent lane, the driving assist device can correctly measure the position of the vehicle in the direction of the width of the road, and can perform a driving assist (notification) according to the travelling state of the vehicle 13 determined from the vehicle position.

Although in above-mentioned Embodiment 1 the case in which the vehicle 13 is travelling in a center lane of a three-lane road having side walls 16a and 16b, this embodiment can also be applied to a case in which the vehicle is travelling in a center lane of a three-lane road having guardrails instead of the side walls. Further, as long as the vehicle is travelling along a road in which roadside objects to which the driving assist device can detect the distance from the right and left sides of the vehicle 13 by using the ultrasonic sensors 3a and 3b mounted on both the sides are disposed, this embodiment can also be applied regardless of the number of lanes of the road.

Further, in accordance with this Embodiment 1, the vehicle position correcting unit 9 determines that the road width of the road along which the vehicle 13 is travelling is uniform when the sum of the distance data on both the right and left sides of the vehicle 13 which are detected by the ultrasonic sensors 3a and 3b is constant. By doing in this way, the driving assist device can carry out a complementary type of measurement on the condition that the road width is uniform. For example, in the examples of FIGS. 10 and 11, the driving assist device deletes the distance data which has varied to correct the distance data on the assumption that the road width is uniform.

In addition, because the driving assist device in accordance with this Embodiment 1 includes the space-between-vehicles determination unit 10 for successively receiving the distance data which the vehicle position correcting unit 9 has determined have a time-varying change equal to or larger than a predetermined threshold, and, when the distance shown by the distance data decreases with the passage of time, determines that the vehicle 13 and another vehicle 15 are approaching each other, and for, when the distance shown by the distance data then increases after being held constant for a short time, determines that the other vehicle 15 has moved away from the vehicle 13 after travelling in parallel with the vehicle 13, the driving assist device can detect an approach or the like of the other vehicle 15 travelling in an adjacent lane, or the like to the vehicle 13.

In addition, in accordance with this Embodiment 1, the travelling state determination unit 11 compares the vehicle position in the direction of the road width which is corrected by the vehicle position correcting unit 9 with lane data on the road which the travelling state determination unit has specified from the map information by using the vehicle position information, and then determines whether the vehicle 13 has deviated from the driving lane in synchronization with the direction indication of the blinker 5. When the travelling state determination unit 11 determines that the vehicle 13 has deviated from the driving lane without being synchronized with the direction indication of the blinker 5, the notification unit 12 provides a warning to that effect. By doing in this way, the driving assist device can improve the safety of the vehicle at the time that the vehicle deviates from the driving lane.

### Embodiment 2

While a driving assist device in accordance with this Embodiment 2 fundamentally has the same structure as that in accordance with Embodiment 1, a travelling state determination unit in accordance with this Embodiment 2 differs from that in accordance with Embodiment 1 in that the travelling state determination unit determines whether or not a vehicle is travelling in a zigzag direction, i.e., being in a so-called “unsteady travelling” state as a travelling state of the vehicle. Therefore, refer to FIG. 2 for information about the structure of the driving assist device in accordance with Embodiment 2.

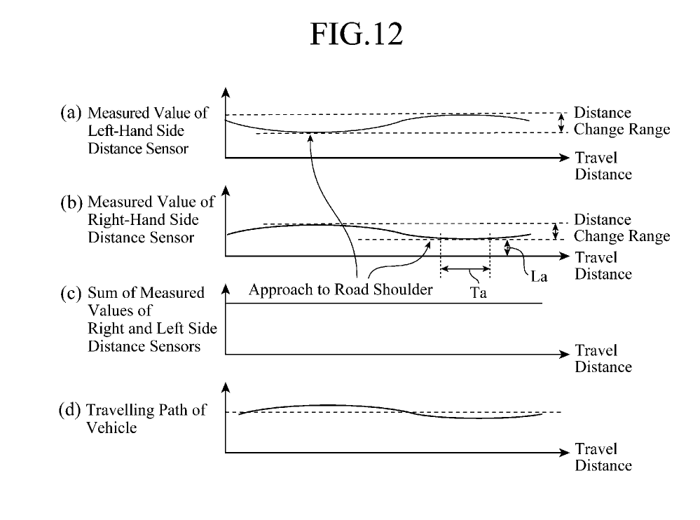

FIG. 12 is a view for explaining a process of determining the travelling state which is carried out by the travelling state determination unit 11 in accordance with Embodiment 2. The travelling state determination unit 11 successively receives distance data showing the position of the vehicle in a direction of the width of the road which is corrected by a vehicle position correcting unit 9 as time series information showing the vehicle position in the direction of the road width, and determines the travelling state of the vehicle 13 by using this time series information.

At this time, as shown in FIGS. 12(a) and 12(b), when each of the distance data on both the right and left sides of the vehicle 13 has a time-varying change (referred to as a distance change range from here on) equal to or smaller than a predetermined threshold, and changes in value in synchronization with travelling path data of the vehicle 13 shown in FIG. 12(d), and a travelling path acquired from the travelling path data of the vehicle 13 does not match the geometry of the road specified from map information by using the vehicle position information, the travelling state determination unit 11 determines that the travelling state of the vehicle 13 is an “unsteady travelling” one.

The travelling state determination unit determines whether each of the time series distance data on both the right and left sides of the vehicle 13 changes in synchronization with the travelling path data of the vehicle 13 by, for example, determining that the vehicle is travelling in a zigzag direction from the travelling path data of the vehicle 13, and determining whether the distance data on both the right and left sides of the vehicle 13 change in opposite phase and whether the time series information of the sum of the distance data on both the sides shows that the distance is constant, as shown in FIG. 12(c).

Thus, although the travelling state determination unit cannot make a distinction between unsteady travelling and curve travelling by using only the travelling path data of the vehicle, the travelling state determination unit can exactly detect an unsteady travelling state of the vehicle by using the time series distance data on both the right and left sides of the vehicle.

Further, when the distance shown by either one of the distance data on both the right and left sides of the vehicle 13 (the right-hand side distance in the example shown in FIG. 12(b)) is equal to or shorter than the predetermined threshold La and this state continues for a predetermined time interval Ta or longer, the travelling state determination unit 11 determines that the vehicle 13 is travelling on a road shoulder, and then commands a notification unit 12 to notify to that effect. The notification unit 12 notifies the driver that the vehicle 13 is travelling on a road shoulder by using a warning or an alarm display.

As mentioned above, in accordance with this Embodiment 2, when each of the distance data on both the right and left sides of the vehicle 13 showing the vehicle position corrected by the vehicle position correcting unit 9 has a time-varying change equal to or smaller than the predetermined threshold, and changes in value in synchronization with the travelling path of the vehicle 13, and the travelling path of the vehicle 13 does not match the geometry data on the road specified from the map information, the travelling state determination unit 11 determines that the vehicle 13 is in an unsteady travelling state in which the vehicle is moving from side to side and the notification unit 12 provides a warning about the travelling state determined by the travelling state determination unit 11 to the driver. By doing in this way, while providing the same advantages as those provided by above-mentioned Embodiment 1, the driving assist device can exactly detect “unsteady” travelling resulting from dozing off while driving or the like and can warn the driver of the unsteady travelling.

Further, in accordance with this Embodiment 2, when the distance shown by either one of the distance data on both the right and left sides of the vehicle 13 showing the vehicle position corrected by the vehicle position correcting unit 9 is equal to or shorter than the predetermined threshold La and this state continues for the predetermined time interval Ta or longer, the travelling state determination unit 11 determines that the vehicle 13 is travelling on a road shoulder, and the notification unit 12 provides a warning about the travelling state determined by the travelling state determination unit 11 to the driver. By doing in this way, while providing the same advantages as those provided by above-mentioned Embodiment 1, the driving assist device can exactly detect travelling on a road shoulder of the vehicle 13, and can warn the driver of the travelling on a road shoulder.

### Embodiment 3

While a driving assist device in accordance with this Embodiment 3 fundamentally has the same structure as that in accordance with Embodiment 1, a vehicle position correcting unit in accordance with this Embodiment 3 differs from that in accordance with Embodiment 1 in that when a reflected wave is frequently observed through a one-time transmission of ultrasonic waves from ultrasonic sensors disposed on right and left sides of a vehicle, the driving assist device sets the reception sensitivity of each of the ultrasonic sensors to low while setting the transmission sensitivity of each of the ultrasonic sensors to high, and, when the speed of the vehicle is higher than a predetermined speed, sets the transmission and reception sensitivities of each of the ultrasonic sensors to high. Therefore, refer to FIG. 3 for information about the structure of the driving assist device in accordance with Embodiment 3.

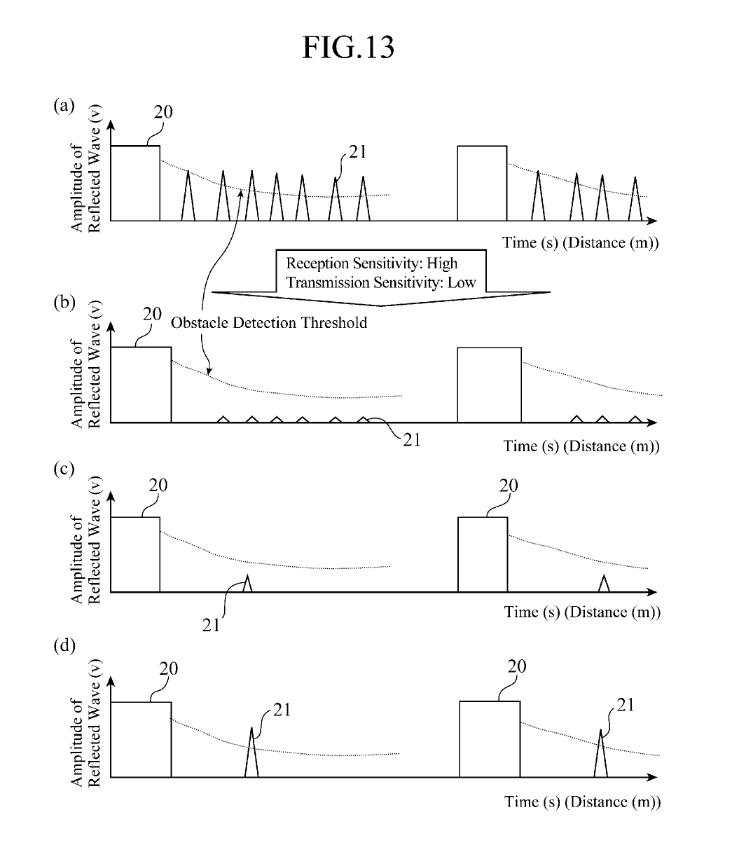

FIG. 13 is a view for explaining adjustment of the transmission sensitivity and the reception sensitivity of each of the ultrasonic sensors which is carried out by the vehicle position correcting unit 9 in accordance with Embodiment 3. As shown in FIG. 13(a), when a reflected wave 21 is frequently observed through a one-time transmission of a transmission pulse 20 of an ultrasonic wave from each of the ultrasonic sensors 3a and 3b (when a reflected wave 21 is received a number of times equal to or larger than a predetermined threshold number of times), it can be expected that these reflected waves result from mixing of a disturbance noise, such as a brake sound of another vehicle travelling, a whizzing sound, or a drain sound of rain water.

Therefore, in the above-mentioned case, the vehicle position correcting unit 9 in accordance with Embodiment 3 sets the transmission sensitivity of each of the ultrasonic sensors 3a and 3b to high while setting the reception sensitivity of each of the ultrasonic sensors to low. As a result, the vehicle position correcting unit can reduce the amplitude of each reflected wave resulting from a disturbance noise to lower than an obstacle detection threshold of the ultrasonic sensors 3a and 3b, as shown in FIG. 13(b), and can reduce the frequency of erroneous detection caused by a disturbance noise.

Further, as shown in FIG. 13(c), when the vehicle is travelling at a high speed, a reflected wave from an obstacle has a tendency of amplitude to become low as compared with a case in which the vehicle is travelling at a low speed.

Therefore, the vehicle position correcting unit 9 in accordance with Embodiment 3 monitors the speed of the vehicle 13 at all times by using wheel speed data acquired from wheel speed sensors 4a and 4b, and, when the speed of the vehicle 13 becomes higher than a predetermined speed Vo, sets the transmission sensitivity and the reception sensitivity of each of the ultrasonic sensors 3a and 3b to high.

As a result, the reduction of the obstacle detectability of each of the ultrasonic sensors 3a and 3b resulting from increase in the speed of the vehicle can be prevented.

As a method of increasing the transmission sensitivity of each of the ultrasonic sensors 3a and 3b, (1) a method of increasing an excitation voltage, and (2) a method of increasing the number of excitation pulses can be provided.

As mentioned above, in accordance with this Embodiment 3, each of the ultrasonic sensors 3a and 3b receives a reflected wave of an ultrasonic wave transmitted thereby from an object to be detected, and detects the distance to the object to be detected, and, when a reflected wave is received a number of times equal to or larger than the predetermined threshold number of times through a one-time transmission of the ultrasonic wave from each of the ultrasonic sensors 3a and 3b, the vehicle position correcting unit 9 sets the transmission sensitivity of each of the ultrasonic sensors 3a and 3b to higher than before while setting the reception sensitivity of each of the ultrasonic sensors to lower than before. By doing in this way, while providing the same advantages as those provided by above-mentioned Embodiment 1, the driving assist device can reduce the frequency of erroneous detection caused by a disturbance noise, such as a brake sound of another vehicle travelling, a whizzing sound, or a drain sound of rain water.

Further, in accordance with this Embodiment 3, when the speed of the vehicle 13 becomes higher than the predetermined speed, the vehicle position correcting unit 9 sets the transmission sensitivity and the reception sensitivity of each of the ultrasonic sensors 3a and 3b to higher than before. By doing in this way, the driving assist device can prevent the reduction of the obstacle detectability of each of the ultrasonic sensors 3a and 3b.

### INDUSTRIAL APPLICABILITY

Because the driving assist device in accordance with the present invention can correctly measure the position of a vehicle in a direction of the width of the road along which the vehicle is travelling, and can perform a travelling assist (notification) according to the travelling state of the vehicle determined from the vehicle position, the driving assist device in accordance with the present invention can be used effectively for a car navigation system and so on.

1. A driving assist device comprising:
a vehicle position detecting unit for detecting a position of a vehicle in a direction of a width of a road along which the vehicle is travelling by using both distance data on at least one of distances from both right and left side surfaces of the vehicle to an object to be detected which are detected by distance sensors mounted on both the right and left side surfaces of the vehicle for detecting the distances from the both side surfaces to an object, and road width data on the width of the road which is specified from map information by using vehicle position information;
a vehicle position correcting unit for determining a travelling path of the vehicle on a basis of wheel speeds of right and left wheels of at least one of front and rear wheelsets of said vehicle, the wheel speeds being detected by wheel speed sensors for detecting the wheel speeds of said right and left wheels, and for specifying distance data having a time-varying change equal to or larger than a predetermined threshold from among the distance data showing said vehicle position which is detected by said vehicle position detecting unit to correct the vehicle position in such a way that the vehicle position is shown by the distance data from which said specified distance data are removed when the travelling path of said vehicle shows a straight ahead movement;
a travelling state determination unit for determining a travelling state of said vehicle from a time-varying change of the vehicle position in the direction of the width of said road which is corrected by said vehicle position correcting unit; and
a notification unit for notifying a content according to the travelling state determined by said travelling state determination unit.

2. The driving assist device according to claim 1, wherein when a sum of the distance data on the distances from both the right and left side surfaces of the vehicle to the object is constant, the distances showing said vehicle position detected by said vehicle position detecting unit, said vehicle position correcting unit determines that the road width of said road is uniform.

3. The driving assist device according to claim 1, wherein said driving assist device includes a space-between-vehicles determination unit for successively receiving the distance data which said vehicle position correcting unit has determined have a time-varying change equal to or larger than said predetermined threshold, and, when a distance shown by the distance data decreases with a passage of time, determines that the vehicle and the object to be detected are approaching each other, and for, when the distance shown by the distance data then increases after being held constant for a short time, determines that said object to be detected has moved away from said vehicle after travelling in parallel with said vehicle.

4. The driving assist device according to claim 1, wherein when each of the distance data on both the right and left sides of the vehicle showing said vehicle position corrected by said vehicle position correcting unit has a time-varying change equal to or smaller than said predetermined threshold, and changes in value in synchronization with the travelling path of said vehicle, and the travelling path of the vehicle does not match geometry data on the road along which said vehicle is travelling, said geometry data being specified from said map information, said travelling state determination unit determines that said vehicle is in an unsteady travelling state in which said vehicle is moving from side to side and said notification unit provides a warning of said travelling state determined by said travelling state determination unit.

5. The driving assist device according to claim 1, wherein when the distance shown by either one of the distance data on both the right and left sides of the vehicle showing said vehicle position corrected by said vehicle position correcting unit is equal to or shorter than a predetermined threshold and this state continues for a predetermined time interval, said travelling state determination unit determines that said vehicle is travelling on a road shoulder, and said notification unit provides a warning of said travelling state determined by said travelling state determination unit.

6. The driving assist device according to claim 1, wherein said travelling state determination unit compares the vehicle position in the direction of the width of said road which is corrected by said vehicle position correcting unit with lane data on said road which said travelling state determination unit has specified from said map information by using said vehicle position information, and then determines whether said vehicle has deviated from a driving lane in synchronization with a direction indication of a blinker, and, when said travelling state determination unit determines that said vehicle has deviated from said driving lane without being synchronized with the direction indication of the blinker, said notification unit provides a warning to that effect.

7. The driving assist device according to claim 1, wherein each of said distance sensors receives a reflected wave of a detection wave transmitted thereby from an object to be detected and detects a distance between itself and said object to be detected, and, when a reflected wave is received a number of times which is equal to or larger than a predetermined number of times through a one-transmission of a detection wave from one of said distance sensors, said vehicle position correcting unit sets transmission sensitivity of said distance sensor to higher than before and sets reception sensitivity of said distance sensor to lower than before.

8. The driving assist device according to claim 1, wherein each of said distance sensors receives a reflected wave of a detection wave transmitted thereby from an object to be detected and detects a distance between itself and said object to be detected, and, when said vehicle has a speed higher than a predetermined speed, said vehicle position correcting unit sets transmission sensitivity and reception sensitivity of said distance sensors to higher than before.
